(19) United States
(12) Patent Application Publication
(10) Pub. No.: US 2004/0156483 A1
(43) Pub. Date: Aug. 12, 2004

(54) Unified messaging communication method and system with user-specific announcement message

(76) Inventor: Michael Theobald, Herxheim (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/476,720

(22) PCT Filed: May 6, 2002
(86) PCT No.: PCT/EP02/04973

(30) Foreign Application Priority Data
May 4, 2001 (DE) 101 21 705.6
May 4, 2001 (DE) 101 21 704.8

(51) Int. Cl. H04M 11/00; G06F 15/16

(52) U.S. Cl. 379/88.13; 709/206; 379/88.25

(57) ABSTRACT

The invention relates to a unified messaging communication method and a unified messaging communication system (13), said system being capable of being used in common by several users. The inventive communication system comprises a first central computer (3) connectable to the Internet. According to the invention, messages addressed to one user or one group of users can be stored in said computer for later enquiry by the corresponding user or by a member of the user group. Said messages are sent by another user to said user or user group by means of a corresponding message transmission protocol selected from a group of different protocols, and are transmitted to the first computer (3) by means of an intermediary connection of at least one other computer (6). Said central computer (3) comprises a telephone-answering module (10) using a user-specific text which can be determined by the corresponding user or by a member of the corresponding user group.

The invention relates to a unified messaging and communication system according to the generic part of Claim 1, as well as to a unified messaging and communication method according to the generic part of Claim 13.

Data transmission via the Internet continues to grow in importance. Here, for example, a central computer communicates, for instance, with a remote—stationary or portable—computer, with a cellular phone, etc. The communication takes place using so-called Internet protocols, especially the Transmission Control Protocol (TCP) and the Internet Protocol (IP), TCP/IP for short. For this purpose, for instance, software that can understand and evaluate the TCP/IP (socket or TCP/IP stack) is loaded onto the remote computer.

The fastest growing service of the Internet is based on the Hypertext Transfer Protocol (HTTP) and is called the World Wide Web (WWW). Individual documents, so-called websites or web pages, can be transmitted via the World Wide Web.

Before an Internet connection is made between a remote computer and a central computer, the remote computer is first connected, for example, to another associated web host of an Internet service provider (ISP). This is where server software corresponding to the client software (i.e. the browser) runs on the remote computer. Then the web address that belongs to the specifically requested website on the central computer is entered on the remote computer and then an Internet connection is established to said web address by the other ISP web host associated with the remote computer.

The web address is indicated in the form of a domain name or URL (Universal Resource Locator) address associated with the specific website. This address consists of several parts. The first part designates the Internet protocol (character string “http:/”).

Then comes the—optional—character string “www”0 as the designation for the World Wide Web. The next part of the URL address identifies the specific central computer on which the website is stored, and the next part indicates the path to a local directory in which the website is stored on the central computer. The last URL address part specifies the exact file name of the website, which is then transmitted from the central computer—making use of the ISP web host—via the Internet to the remote computer.

In the state of the art, so-called Unified Messaging Systems (UMS) are already known. Here, several communication services based on various technologies, e.g. fax, SMS (Short Message Service), e-mail—utilizing the Internet—are effectuated via a shared, central system.

For example, a UMS user can access a central computer of a UMS provider, where there is a website associated with him/her, at which he/she can retrieve faxes, SMS short messages and e-mails, and he/she can, in turn, send faxes, SMS short messages and e-mails from this website.

Moreover, methods of so-called direct and so-called indirect Internet telephony are known in the state of the art. With direct Internet telephony, a voice signal is picked up by a microphone of a transmitting computer, it is digitized in the sound card of the computer and then compressed. Subsequently an Internet connection to a conventional receiving computer is established. Hence, the individual user of Internet telephony has to know the IP address of his/her communication partners or of their receiving computer. Then the voice data can be transmitted by means of ISDN cards or modems on the transmitting and receiving computers in the form of IP packets via the Internet from the transmitting computer to the receiving computer. There, the received data is decompressed, converted in a sound card of the receiving computer into an analog signal and transmitted to the loudspeaker of the computer. The transmission of voice data in the opposite direction (i.e. from the receiving computer to the transmitting computer) takes place correspondingly in the reverse manner.

In contrast, with so-called indirect Internet telephony, the voice data is transmitted from the transmitting computer to a special telephone network interface computer (so-called gateway computer) instead of to a conventional receiving computer. This gateway computer dials the desired telephone number of a conventional telephone connection and transmits the voice data as an analog signal to the telephone associated with the telephone connection. The voice data is transmitted in the opposite direction (i.e. from the telephone to the transmitting computer) correspondingly in the reverse manner: the telephone network Internet interface computer digitizes the analog voice signal received from the telephone and transmits it to the transmitting computer via the Internet.

The invention is based on the objective of providing a novel unified messaging and communication system, as well as a novel unified messaging and communication method.

The invention achieves the above-mentioned and other objectives by means of the subject matter of Claims 1 and 13.

Accordingly, the invention provides a unified messaging and communication system that can be used jointly by several users, with a first central computer (or with several central computers that jointly fulfill the same functionality as the first computer) that can be connected to the Internet, in which messages addressed to a user or to a group of users can be stored for later retrieval by the corresponding user or by a member of the user group, whereby the messages from another user are sent to said user or user group by means of one of several possible different message transmission protocols, and are transmitted to the first computer (or computers) by making use of at least one other computer,

characterized in that

the central computer has a telephone-answering module using a user-specific text which can be specified by the corresponding user or by a member of the corresponding user group.

Advantageous embodiments of the invention are given in the subclaims.

Especially preferably, the user or user group is associated with a telephone number that has a “012” prefix under which the messages from the other user can be sent to said user or user group. Telephone numbers with a prefix “(0)12” (omitting the first zero from outside of Germany and adding the German country code) can be reserved at the regulatory authorities for telecommunications and postal services (Reg TP) in Germany in order to offer so-called “innovative services”—without further, more detailed specification. Although the possibility to reserve such numbers has already existed for a long time, so far, no such number has been reserved, and no “innovative service” has been offered under such a number.

Below, the invention will be explained in greater detail with reference to an embodiment and to the accompanying drawing. The drawing shows the following:

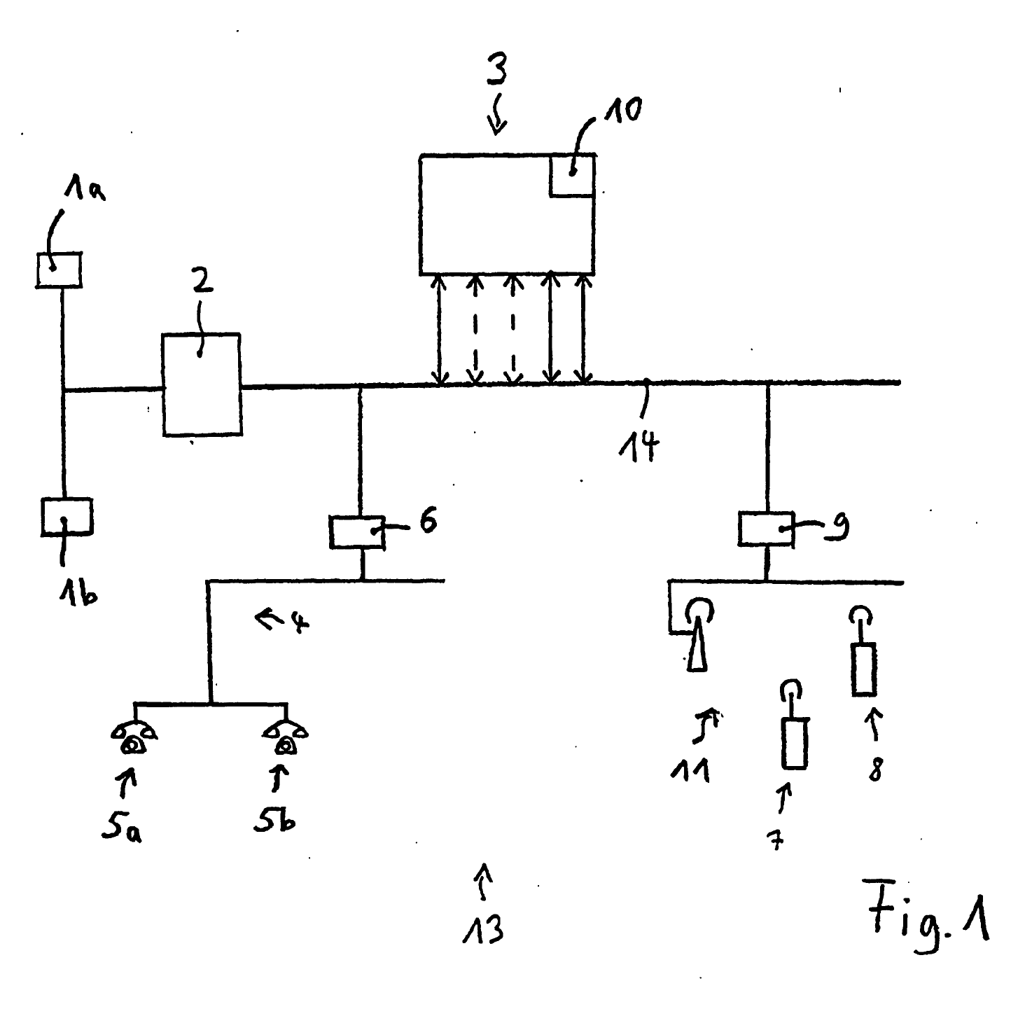

FIG. 1—a unified messaging and data communication system;

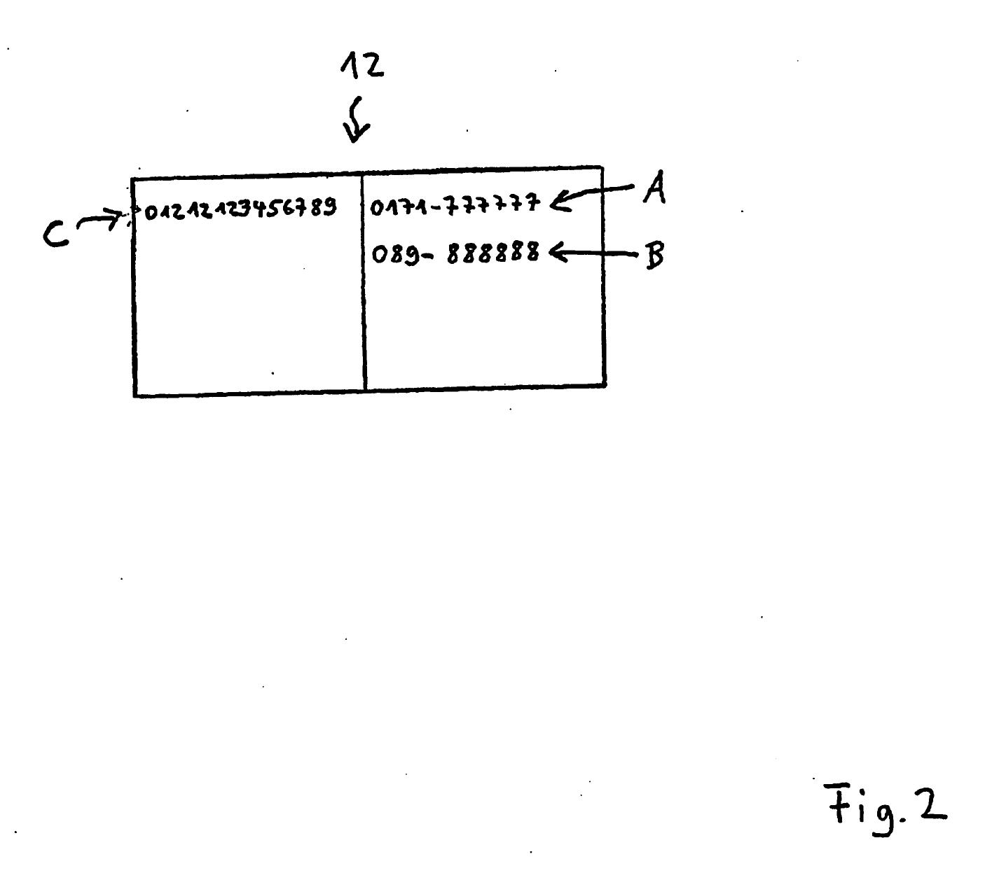

FIG. 2—a telephone number assignment list stored in the central computer shown in FIG. 1 (remark: in an alternative embodiment, not shown here, instead of this central computer, several central computers are used that jointly fulfill the same functionality).

FIG. 1 shows a unified messaging and data communication system 13 according to an embodiment of the invention by means of which—using the Internet 14—several communication services, for example, voice telephony, fax, SMS (Short Message Service), e-mail based on different transmission protocols and/or transmission technologies are effectuated centrally.

The data communication system 13 has a central computer 3 (web host) that is connected to the Internet 14. A first computer 1a associated with a first user and a second computer 1b associated with a second user can be connected to the Internet 14 via a computer 2 of an ISP (ISP=Internet Service Provider). Via the Internet 14, the second user can send, for example, an e-mail from his/her computer 1b to an e-mail address associated with the first user. The e-mail is then stored in a storage device (not shown here) associated with the central computer 3, and can later be retrieved by the first user at a certain Internet address or web site associated with the first user, for example, from his/her computer 1a, or, for example, from his/her GSM, GPRS, WAP, UMTS or from a cellular phone 7 that uses any other transmission protocol.

As is shown in FIG. 1, with the system 13 according to the invention, a first fixed network telephone 5a and a second fixed network telephone 5b (as well as additional fixed network telephones, not shown here) are connected to a public telephone network 4, and the cellular phone 7 as well as additional cellular phones 8 are connected to a wireless cellular network 11. The public telephone network 4 is connected to the Internet 14 via a central computer 6, and the wireless cellular network 11 is connected to the Internet 14 via a central computer 9. The cellular phone 7 is associated with the subscriber phone number “0171-777777” (phone number A), and the first fixed network telephone 5a is associated with the subscriber phone number “089-888888” at which the phones 7, 5a can be called respectively.

A certain phone number that starts with the prefix “012” is associated with all or some of the users of the system 13 (e.g. the phone number “012-12-123456789” (phone number C) to the first user, and the phone number “012-12-123123123” (phone number D) to the second user).

For example, the second user can send an SMS text message to the first user at phone number C (that is to say, at phone number “012-12-123456789”) via the cellular phone 8. The central computer 9 (or the central computer 6) forwards all messages sent under a phone number with a “012” prefix to the central computer 3 (or all messages sent under a phone number with a “012” prefix plus a certain initial number sequence following the prefix (e.g. under a phone number starting with the number sequence “012-12”)). Aside from SMS text messages, these messages can also be telephony voice messages, etc. (see below).

Before the message is forwarded to the central computer 3, the protocol (e.g. SMS) used to send the message in question is converted into an Internet protocol (e.g. TCP/IP) in the central computer 9 (or in the central computer 6).

The message forwarded to the central computer 3 is stored in a storage device (not shown here) associated with the central computer 3 and can later be retrieved by the first user, for example, from his/her computer 1a or, for example, from his/her WAP or cellular phone 7 at the same Internet address associated with the first user in the same manner as, for example, the above-mentioned e-mail.

If the second user—instead of sending an SMS, for example, from the cellular phone 8 (or, for instance, from the fixed network telephone 5b)—wants to send a telephony voice message at phone number C to the first user (i.e. wants to talk to him/her), then in a corresponding manner as described above in conjunction with the sending of an e-mail, first of all a connection is established between the cellular phone 8 (or the fixed network telephone 5b) and the central computer 9 (or central computer 6), and the connection is then forwarded to the central computer 3. The central computers 6, 9 then function as telephone network-Internet interface computers as is known from indirect Internet telephony methods.

A “follow-me” or phone number assignment list is stored in the storage device of the central computer 3 for all of the registered system users. As an alternative or in addition, dialing number sequences can also be used. By way of an example, FIG. 2 shows the telephone number assignment list 12 of the first user. His/Her “012” prefix phone number C (i.e. the phone number “012-12-123456789”) is associated with several phone numbers ranked in order of priority, each belonging to a specific terminal device, (here—with the highest priority—the subscriber phone number “0171-777777” (phone number A) of the cellular phone 7 as well as—with the next-highest priority—the subscriber phone number “089-888888” associated with the first fixed network telephone 5a (phone number B), etc.).

The central computer 3 first tries to establish a connection with the terminal device associated with the phone number A, i.e. the cellular phone 7. If this is not possible (e.g. because the first user does not answer the phone call), after letting the phone ring several times, for example, three times, without success, an attempt is made to establish a connection to the terminal device of next-higher priority that is associated with the phone number B, i.e. the telephone 5a. If this is not possible after letting the phone ring several times, for example, three times, without success, then the second user can leave the first user a voice message that, under the control of a software-based telephone-answering module 10 of the central computer 3, is stored in its storage device. (In principle, the central computer 3—before calling the telephone-answering module 10—can try to establish a connection with any number of additional targets of any kind.)

Before the second user can leave the (telephone-answering machine) voice message, under the control of the telephone-answering module 10, he/she is read a telephone-answering text stored in the central computer 3, e.g. “XXX is not available right now. If you would like to leave a message, please speak after the tone”. The appropriate voice data is transmitted via the Internet 14 and via the appertaining central computers 6, 9 to the specific terminal device that placed the call (here: to the cellular phone 8 or to the fixed network telephone 5b).

The individual users can record their own telephone-answering text. For this purpose, the individual user, for example, the first user, can call the phone number C associated with him/her (that is to say, for instance, the phone number “012-12-123456789”) for example, via the fixed network telephone 5a or via the cellular phone 7. The central computer 9 (or the central computer 6) then correspondingly forwards the connection (on the basis of the selected “012” or “012-12” prefix) to the central computer 3 as described above. This computer performs an authorization check in the manner described below in conjunction with the retrieval of messages. The individual user can then record any desired telephone-answering text in his/her fixed network telephone 5a or cellular phone 7. This voice data is then transmitted by means of the public phone network 4 or the wireless cellular network 11, making use of the appertaining central computer 6, 9, via the Internet 14 to the central computer 3 and stored there as the telephone-answering text.

In order to retrieve his/her messages, the first user can call the phone number C associated with him/her (that is to say, the phone number “012-12-123456789”), for example, via his/her fixed network telephone 5a or cellular phone 7. The central computer 9 (or the central computer 6) correspondingly forwards the connection (on the basis of the selected “012” or “012-12” prefix) to the central computer 3 as described above. In this process, the subscriber phone number of the specific terminal device from which the retrieval is being carried out (i.e. the phone number B of the fixed network telephone 5a, or the phone number A of the cellular phone 7) is also transmitted to the appertaining central computer 6, 9 and from there via the Internet 14 to the central computer 3.

This computer then checks whether the first user is authorized to retrieve the stored messages. For this purpose, for example, a PIN code is requested. As an alternative or in addition, it is checked whether the specific subscriber phone number of the terminal device from which the retrieval is being carried out is stored in the telephone number assignment list 12 that belongs to the specific called “012” phone number (or to the specific user). (Remark: the applicant reserves the right to orient future claims exclusively at the authorization checking system or method pertaining to this retrieval, that is to say, Claims 1, 6 to 8, 13, without the limitation to a certain prefix (Claim 5) and/or without the characterizing part of Claims 1 and 13 that relate to the telephone-answering module).

If the specific subscriber phone number of the terminal device from which the retrieval is being carried out is present in the telephone number assignment list 12, and/or if the PIN transmitted from the specific terminal device is correct, then the user can retrieve the messages that have been stored for him/her. For example, then the e-mails or SMS messages stored for him/her or, for example, the telephony voice messages stored for him/her by the telephone-answering module 10 are played back to him/her by means of a software-based OCR module of the central computer 3 (that is to say, transmitted via the Internet 14 using Internet protocols to the appertaining central computer 6, 9 and from there, for instance, using ISDN or GSM, GPRS, UMTS or any other transmission protocols, via the public telephone network 4 or via the wireless cellular network 11 to the appertaining terminal device, for example, to the fixed network telephone 5a or to the cellular phone 7).

Every registered user can himself/herself specify the subscriber phone numbers A, B (and their priority) contained in the associated telephone number assignment list 12, for example, via the Internet 14, and the Internet address or web site associated with him/her.

Instead of using the same list as a “follow-me” list 12 and as an authorization retrieval list 12 (FIG. 2), in an alternative embodiment (not shown here), it is also possible to maintain two separate lists that can each be established separately in the same manner as the above-mentioned telephone number assignment list via the Internet 14 from the first computer 1a.

In both embodiments, as an alternative or in addition, the specific user can retrieve messages—e.g. SMS short messages and e-mails—addressed to him/her directly via the web site associated with him/her and stored on the central computer 3 (for example, from the first computer 1a), he/she can specify or change a telephone-answering text used by the telephone-answering module 10, and he/she can, in turn, send messages—e.g. SMS short messages and e-mails—from the web site (or to put is more precisely, from his/her personal account).

1. A unified messaging and communication system (13) that can be used jointly by several users, with a first central computer (3) that can be connected to the Internet, in which messages addressed to a user or to a group of users can be stored for later retrieval by the corresponding user or by a member of the user group, whereby the messages from another user are sent to said user or user group by means of one of several different message transmission protocols, and are transmitted to the first computer (3) by making use of at least one other computer (6),
characterized in that
the central computer (3) has a telephone-answering module (10) using a user-specific text which can be specified by the corresponding user or by a member of the corresponding user group.

2. The system (13) according to claim 1, in which the user-specific text can be specified by means of a voice message transmitted to the central computer (3).

3. The system (13) according to claim 2, in which the voice message is transmitted from a telephone (5a, 7) to the central computer (3).

4. The system (13) according to claim 1, in which the user-specific text can be specified by means of a text message transmitted via the Internet to the central computer (3).

5. The system (13) according to one of the preceding claims, in which the user or user group is associated with a telephone number (C) that has a “012” prefix under which the messages from the other user can be sent to said user or user group.

6. The system (13) according to claim 5, in which the user or the member of the user group can retrieve the messages in that the user or the member of the user group calls the phone number (C) associated with him/her or with the user group.

7. The system (13) according to claim 6, which is configured in such a way that the retrieval can be carried out from a terminal device (8) that has a terminal device subscriber phone number (A) that differs from the “012” phone number (C).

8. The system (13) according to claim 7, in which the user or the member of the user group is authenticated as being authorized to retrieve the message if the terminal device subscriber phone number (A) is present in a list (12) of terminal device phone numbers (A, B) associated with the “012” phone number.

9. The system (13) according to one of the preceding claims, in which one of the messages sent by the other user is a telephony voice message.

10. The system (13) according to claim 9, in which the telephony voice message is stored in the central computer (3), especially being controlled by the telephone-answering module (10).

11. The system (13) according to one of claims 1 to 8, in which one of the messages sent by the other user is a telephony text message, especially an SMS text message.

12. The system (13) according to one of claims 1 to 8, in which one of the messages sent by the other user is an e-mail.

13. A unified messaging and communication method for use in a unified messaging and communication system according to one of claims 1 to 12, that can be used jointly by several users, with a first central computer (3) that can be connected to the Internet, in which messages addressed to a user or to a group of users can be stored for later retrieval by the corresponding user or by a member of the user group, whereby the messages from another user are sent to said user or user group by means of one of several different message transmission protocols, and are transmitted to the first computer (3) by making use of at least one other computer (6),
characterized in that
the process comprises the step:
of using a user-specific text which can be specified by the corresponding user or by a member of the corresponding user group through a telephone-answering module (10) provided in the central computer (3).
